(19) United States
(12) Patent Application Publication
(10) Pub. No.: US 2009/0297843 A1
(43) Pub. Date: Dec. 3, 2009

(54) NON-CHROME THIN ORGANIC-INORGANIC HYBRID COATING ON ZINCIFEROUS METALS

(75) Inventors: Choed-Ampai Sitthichai, Bangkok (TH); Jingxian Hong, Shanghai (CN)

Correspondence Address: HENKEL CORPORATION, One Henkel Way, ROCKY HILL, CT, 06067, US

(73) Assignee: Henkel AG & Co. KGaA, Duesseldorf (DE)

(21) Appl. No.: 12/406,591

(22) Filed: Mar. 18, 2009

Related U.S. Application Data
(63) Continuation of application No. PCT/EP2006/009054, filed on Sep. 18, 2006.

(51) Int. Cl. B32B 15/08; C23C 22/05

(52) U.S. Cl. 428/341; 148/251; 148/22

(57) ABSTRACT

The present invention relates to a treatment solution for the deposition of a thin organic/inorganic hybrid coating on a zinciferous metal surface, comprising water and
(i) a concentration of phosphoric acid (A);
(ii) a concentration of dissolved inorganic components (B) containing at least one complex fluoro metallate anion selected from the group of titanium, zirconium, hafnium and/or silicon, preferably hexafluorotitanic acid;
(iii) a concentration of dissolved inorganic components (C) consisting of bivalent cations of zinc (C₁) and/or manganese (C₂);
(iv) a concentration of a dissolved inorganic component (D) consisting of oxoanions of molybdenum;
(v) a concentration of a water soluble and/or water dispersable polymeric compound (E) which is based on a chelating poly(vinylphenol) compound;
(vi) a concentration of a water-soluble and/or water-dispersable polymeric resin (F) being not part of or identical with component (E).

This application is a continuation under 35 U.S.C. Sections 365(c) and 120 of International Application No. PCT/EP2006/009054, filed Sep. 18, 2006 and published on Mar. 27, 2008 as WO 2008/034449, which are incorporated herein by reference in their entirety.

The present invention refers to a treatment solution for the deposition of a thin homogenous organic-inorganic hybrid coating on a zinciferous metal surface wherein said coating imparts to the treated metal a temporary corrosion protection and an improved adhesion to further applied paints and/or lacquers. Furthermore the invention comprises a process for the treatment of a zinciferous metal surface especially in the coil coating industry as well as the use of such a metal substrate coated with a thin organic-inorganic hybrid coating in white goods and electronic housing production.

A temporary corrosion protection of zinciferous materials especially zinc coated or alloyed zinc coated steel strips is usually provided by protective oils or if necessary by conversion treatments like phosphating or chromating. The term “conversion treatment” herein is referred to a treatment of a metal surface with an aqueous solution during which the native metal surface layer is converted to an inorganic layer that is comprised of cations and anions from the aqueous treatment solution as well as of cations of the base metal treated in such a way. The scope of the conversion treatment of metals is to impart the metal with a protective layer against corrosion and to provide a joint layer that promotes the adhesion between the metallic surface and further applied organic coatings.

Surface finishing of zinciferous materials in the building or automotive industry or for the electronic market or in white goods production is usually accomplished by a multi step process which comprises a pre-treatment step or degreasing step, during which the metal surface is cleaned from residual oil and hard water residues or other organic surface contaminations, the formation of a barrier coating by a conversion treatment and the application of organic coatings such as primers, paints, lacquers or electrophoretic coatings. Depending on the substrate and the specific requirements of the coating the conversion treatment is followed by an additional passivating rinse that further contributes to the corrosion resistance and the adhesion properties of the barrier coating. Depending on the metal substrate a subsequent chromate passivating rinse has been particularly introduced to cure defects in the phosphate coating such as microscopic pores and cracks and to improve the paint adhesion to the inorganic barrier coating.

In prior art best results concerning the corrosion protection and the adhesion to further applied organic coatings have been achieved with chromate conversion treatments. The phosphating process for the build-up of an effective barrier coating is a well established process in the automotive industry but itself is a sophisticated multi-step process that requires an extensive control of bath parameters and also yields less decorative coatings compared to the chromating process. Since these chromate coatings contain hazardous hexavalent chromium, the surface finishing industry aims to substitute the chromate conversion process and thus to follow national and regional legislation that just recently became effective in the European Union on the basis of the EU directives on waste electrical and electronic equipment (2002/95/EC) and on the recovery and recycling of end-of-life vehicles (2000/53/EC; 2005/673/EC). Many efforts have been made to develop a phosphating process of zinciferous metals that meets the requirements of a temporary corrosion protection and also provides a considerable adhesion to organic coatings applied to the phosphated zinc substrate without the need of additional steps such as an activation step prior to the phosphating step and an additional passivating rinse, e.g. a chromate post-treatment. Especially, “no-rinse” or “dry-in-place” applications are strongly favored since they provide an one-step process during which a barrier coating is formed that also may comprise a first organic layer adherent to the metal part to be protected.

A post-phosphating rinse alternative to the chromate treatment is disclosed in U.S. Pat. No. 5,298,289. Herein aqueous solutions of polyvinyl phenol compounds also comprising Mannich derivatives thereof are applied to conversion treated metal surfaces to enhance hydrophilicity of the surface and therefore to ease wetting of these surfaces with paints and lacquers. Moreover, these polymers are capable to crosslink with organic coatings and thus to provide an improved adhesion to the paint system. U.S. Pat. No. 5,298,289 also teaches that the polyvinyl phenol compounds containing treatment solution may also comprise ingredients typical for conversion treatment of metal surfaces. Furthermore, it had been suggested to use polyvinyl phenol compounds as an additional component in organic film forming compositions such as paint and electrocoat systems to improve the adhesion of the organic coating to the bare metal surface or conversion treated metal surface.

US 2002/0011281 describes a zinc phosphating solution that also contains small amounts of organic polymers such as complexing substituted poly-(4-vinylphenol) compounds. According to this invention, the chromate passivating step can be omitted, when the surface treatment is performed with a phosphating solution comprising less than 500 ppm of the aforementioned organic polymer. Such a phosphating process results in an inorganic coating that is mainly constituted of a zinc phosphate layer with a film weight of more than 3 g/m². This phosphating treatment is especially designed to align with subsequent surface finishing steps such as applying an electrocoating or a powder coating, which are indispensable to fulfill the high quality standards of the automotive industry.

Another chromium-free treatment solution for the corrosion protection of zinc based metal surfaces is disclosed in US 2003/0150524. The treatment solution according to this invention deviates from a typical phosphating bath as it also contains complex fluorides such as titanium and/or zirconium while the amount of phosphoric acid is less than 1.45 g/l. In addition, small amounts of an organic polymer especially derivatives of polyvinyl phenol, have been added to the treatment solution in order to substitute an additional passivating rinse after the conversion treatment and thus to cut down an additional process step in the phosphating industry. Altogether, this conversion treatment is designed to provide a thin protective coating, which is mainly composed of an inorganic phosphate layer that shows no crystallinity and thus is especially useful as a treatment for the cutting edge protection of already phosphated metal parts or for partially phosphated metal parts of semi-finished products for example in assembly lines.

The usage of substituted poly-(4-vinylphenol) compounds as a component in phosphating baths similar to the ones described in US 2003/0150524 that further comprise film forming polymers is disclosed in WO 99/19083 and WO 00/71626. Again the poly-(4-vinylphenol) compounds were introduced to promote cross-linking to the functional moieties of the film forming polymers and thus to enhance the adhesion of the organic coating. Applying such a surface treatment inherently results in the formation of an organic-inorganic hybrid coating since the conversion process and the precipitation of film forming polymer molecules occurs at least partially simultaneously and independently from each other. In such a hybrid coating the organic polymer molecules may be deposited within the micro- or nanopores of the inorganic matrix and thus act as a binder within the barrier coating. Furthermore, the incorporation of the organic polymer molecules may significantly increase the adhesion to the organic coating provided by the film forming polymer component. As the process of conversion layer formation is initiated by corroding the metal surface but the formation of the organic coating during the process of curing respectively drying of the treatment solution (“dry-in-place” application), it is essentially important to balance the film forming process with respect to the inorganic conversion layer formation to assure that an organic-inorganic hybrid coating with optimum corrosion resistance and adhesion properties is formed.

WO 00/71626 teaches that the presence of poly-(4-vinylphenol) compounds alone that may both cross-link with the film forming polymer and also adhere to the inorganic matrix is not sufficient to provide a reasonable anti-corrosion performance. According to WO 00/71626 it is therefore mandatory to add organophosphonic acids to the coating formulation in order to achieve an organic-inorganic hybrid coating with a suitable corrosion resistance. Following WO 99/19083 a formulation for the formation of an organic-inorganic hybrid coating based on phosphating chemistry is disclosed that does not comprise any bivalent cations of manganese and zinc in order to balance the film forming process with respect to the inorganic conversion layer formation. It is known from state-of-the-art phosphating processes that the lack of manganese and/or zinc ions typically results in the formation of less protective inorganic conversion coatings as they are crucial parameters for the formation rate and thus for the morphology of the barrier coating. In general, the formulations for the deposition of organic-inorganic hybrid coating based on phosphating chemistry fail in providing long-term stability and tend to accumulate sludge. This is due to the fact that the water-dispersable or water-dissolved film forming polymers are mainly constituted of functional moieties such as carboxylates and/or hydroxylates that carry a negative charge. Consequently, ionic interaction of negatively charged dispersed polymer particles or dissolved polymer molecules with cations, especially bivalent or multivalent cations that are typical in phosphating chemistry, e.g. zinc and/or manganese, may lead to an aggregation and also precipitation of polymer particles in the treatment formulation.

Despite of the substantial prior art related to processes in the field of applying organic-inorganic hybrid coating based on phosphating chemistry there is a need for improving the anti-corrosion performance of such coatings, especially by means of adjusting the parameters that control the deposition process, as well as to formulate treatment solutions which exhibit a long-term stability in order to impart reliability to the technical process of surface treatment. Furthermore, the performance of the hybrid coating formed in industrial dry-in-place applications is strongly affected by residual inorganic components such as phosphate, zinc, manganese and/or fluorometallates that have not been deposited at the metal surface during the conversion process and thus remain trapped within the organic matrix. These residues may give rise to chemical degradation processes of the organic matrix within the hybrid coating and therefore have to be avoided or disposed effectively. Another prerequisite for the formation of organic-inorganic hybrid coatings with excellent properties consists in supplying formulations that result in a homogeneous coverage of the metal surface by the thin coating. This is especially important for industrial processes where the metal material has to be imparted with a temporary corrosion protection prior to the forming and assembly of metal parts. Typical applications can be found in the metal-working industry or for manufacturers of domestic appliances, white goods and electronic housings. In particular, the electronic industry sets high quality standards that guarantee an effective shielding of their housings to protect their valuable devices from electromagnetically induced damages. In that respect, the organic-inorganic hybrid coating should have a considerable low electric resistance provided by a relative small thickness of the coating while simultaneously exhibiting an excellent anti-corrosion performance, which in turn requires at least a metal substrate homogeneously covered by the hybrid coating.

Surprisingly, the present inventors found that a treatment of a zinciferous metal surface such as a hot-dip galvanized, electrolytically galvanized or galvannealed steel surface or any other alloyed or unalloyed zinc surface with a solution comprising water and
(i) a concentration of phosphoric acid (A);
(ii) a concentration of dissolved inorganic components (B) containing at least one complex fluoro metallate anion selected from the group of titanium, zirconium, hafnium and/or silicon, preferably hexafluorotitanic acid;
(iii) a concentration of dissolved inorganic components (C) consisting of bivalent cations of zinc (C₁) and/or manganese (C₂);
(iv) a concentration of a dissolved inorganic component (D) consisting of oxoanions of molybdenum;
(v) a concentration of a water soluble and/or water dispersable polymeric compound (E) which consists of a number (n) of x-(N-R₁-N-R₂-aminomethyl)-4-hydroxy-styrene monomer units, where x=2,3,5 or 6 represents the substitution position number, R₁ represents an alkyl group containing from 1 to 4 carbon atoms and R₂ represents a substituent group conforming to the general formula H(CHOH)ₘCH₂—, where m is an integer from 3 to 5, capable of chelating component (B) and/or (C);
(vi) a concentration of a water-soluble and/or water-dispersable polymeric resin (F) being not part of or identical with component (E)
   yields a thin organic-inorganic hybrid coating with excellent anti-corrosion performance, paint adhesion and protection against fingerprint stains.

The water soluble and/or water dispersable polymeric compound (E) preferably accords with the following general constitutional formula (I)

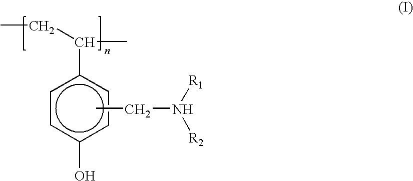

with R₁ and R₂ being substituents as defined above.

According to this invention an organic-inorganic hybrid coating with optimum performance is obtained when the treatment solution that contains an amount of component (C₁) is composed in a way that the molar ratio (C₁): (n·E) of the zinc cations (C₁) to the chelating moieties of the polymer compound with (n·E) being the number (n) of monomer units of the polymeric compound (E) is close to the stoichiometric ratio and preferably not more than 0.75, but at least 0.34, and most preferably 0.68. A ratio of the zinc cations (C₁) with respect to the chelating compound (E) in the preferred range impedes the precipitation of film forming polymers (F) and thus imparting a long-term stability to the treatment solution and ensures during dry-in-place applications an effective conversion layer formation within typical processing times in industrial surface finishing and facilitates the incorporation of residual components A-E into the hybrid coating. A stoichiometrically exceeding amount of the poly(vinylphenol) compound (E) causes a less effective conversion layer formation.

The stoichiometric ratio herein is based on the following general complex formation reaction:

nZn²⁺+E→[ZnₙE]²ⁿ⁺

where stoichiometry accords to an equimolar conversion of the zinc cations with the number (n) of monomer units of the poly(vinylphenol) compound (E).

In the case that the treatment solution does not contain any amount of zinc cations (C₁) the molar ratio (C₂): (n·E) of the manganese cations (C₂) to the chelating moieties of the polymer compound with (n·E) being the number (n) of monomer units of the polymeric compound (E) has to be not more than 0.62 and preferably not more than 0.47, but at least 0.22, and most preferably 0.42, in order to provide a sufficient amount of chelating moieties for the zinc cations that originate from the pickling of the metal surface during the treatment according to this invention.

The molar concentrations of the other compounds of the treatment solution should further comply with the following specific molar ratios:
(i) molar ratio (B): (A) of the total equivalent hydrogen concentration of the components (B) containing complex fluoro metallate anions and the equivalent hydrogen concentration of phosphoric acid (A) is at least 0.1, preferably at least 0.3, but not more than 0.6 and preferably not more than 0.5, and most preferably 0.38.
(ii) molar ratio (B): (C₁) of the components (B) and (C₁) is at least 2.0, but not more than 3.5 and preferably not more than 2.5, and most preferably 2.3, and/or molar ratio (B) : (C₂) of the components (B) and (C₂) is at least 1.2, but not more than 2.4, preferably not more than 1.8, and most preferably 1.4;
(iii) molar ratio (D): (C₁) of the components (D) and (C₁) is at least 1:50, preferably at least 1:40, but not more than 1:20 and preferably not more than 1:25, and most preferably 1:30, or molar ratio (D): (C₂) of the components (D) and (C₂) is at least 1:80, preferably at least 1:60, but not more than 1:20 and preferably not more than 1:30, and most preferably 1:45.

The treatment solution formulated in such a way provides long-term stability against segregation and/or precipitation of the dissolved, dispersed or both dissolved and dispersed resin (F) up to a temperature of at least 30° C., preferably at least 40° C. and up to temperatures of about 45° C.

In order to ensure a proper deposition rate of the organic-inorganic hybrid coating the treatment solution contains a mass fraction of phosphoric acid (A) in said solution of at least 0.5 wt.-%, preferably at least 1.0 wt.-% and most preferably at least 2.0 wt.-%, but not more than 3.0 wt.-%, whereas the amount of the remaining compounds of the treatment solution is predefined by the aforementioned molar ratios.

With respect to the content of bivalent cations the treatment solution might also be formulated in a way that the total mass fraction of bivalent cations supplied by the dissolved inorganic compounds (C) in said solution is at least 0.2 wt.-%, preferably at least 0.4 wt-%, but not more than 1.2 wt.-% and preferably not more than 0.8 wt.-%, whereas the amount of the remaining compounds of the treatment solution is predefined by the aforementioned molar ratios.

Generally, the treatment solution can be applied to the metal surface according to conventional industrial coating techniques such as immersing, spraying, wiping and squeegee and/or roller applications.

According to this invention the metal surface that has been brought into contact with the treatment solution using these coating techniques has to be dried subsequently to the application of the treatment solution. Such a process is denoted in the coating industry as a dry-in-place application and/or no-rinse application. After evaporation of the volatile compounds of the treatment solution adherent to the metal surface the hybrid coating is formed, which is composed of a mainly inorganic conversion layer at the metal surface covered by a homogeneous resin coating of component (F) that also includes residual components (A-D). Since the formation rate of the conversion layer, which is mainly constituted of inorganic components, is determined by the relative amounts of components (A-D), the final film weight of the organic-inorganic hybrid coating obtained after drying can be adjusted by the amount of the water-soluble and/or water-dispersable polymeric resin (F) in the treatment solution.

Therefore the mass fraction of the water-soluble and/or water-dispersable polymeric resin (F) within the treatment solution can be chosen independently from the other components , but should be at least 5 wt.-%, preferably at least 15 wt.-%, but not more than 50 wt.-% and preferably not more than 25 wt.-% to attain a film weight of at least about 0.4 g/m², preferably at least 0.6 g/m², but not more than about 1.6 g/m² and preferably not more than 0.8 g/m² and to ensure the formation of an organic-inorganic hybrid coating with the desired performance as described before.

According to this invention the dry-in-place process of the surface treated metal part also includes the formation of the homogeneous hybrid coating via hardening and/or cross-linking of the polymeric resin (F) at a peak metal temperature of not more than 150° C., preferably not more than 120° C., but at least 65° C. and preferably at least 80° C. Therefore, the water-soluble and/or water-dispersable polymeric resin (F) preferably has a film formation temperature not higher than 80° C., more preferably not higher than 60° C. and most preferably not higher than 45° C. The polymeric resin (F) can be any water-dispersable polymeric compound that is in addition to the aforementioned prerequisites capable of hardening or cross-linking such as acrylics, urethanes, phenolics, vinyls and epoxies.

The present invention also comprises a treatment solution of the components A-F as described before that additionally contains a stable dispersed solid material (G) that in isolated form has a coefficient of static friction, measured between the solid material itself and cold rolled steel, that is not greater than 0.35, where the mass ratio of component (G) to the component (F) is at least 0.01, but not more than 1 and preferably 0.04. Said solid material is preferably based on oxidised polyethylene wax. Adding the wax to the treatment solution according to the preferred amounts reduces the coefficient of friction of the coating which is especially important for the forming and transportation of metal strips and coils. Higher amounts of the wax lead to a deterioration of the paintability of the coating.

The zinciferous metal substrate with a thin organic/inorganic hybrid coating obtained by a process according to this invention is also enclosed, wherein the surface resistance of said substrate determined with a 4-point resistance measurement method following the industrial standard IBM SG-PR-000857 is not more than 1.5 mωand preferably not more than 1 mω.

Such a zinciferous metal substrate with a thin organic-inorganic hybrid coating with a film weight of at least 0.4 g/m², preferably at least 0.6 g/m², but not more than 1.6 g/m² and preferably not more than 0.8 g/m², provides sufficient temporary corrosion protection, can be processed in industrial assembling and forming routines and for applying a multi-layer coating to said substrate in industrial metal surface finishing such as coil coating, car body painting lines, white goods and electronic housing production.

Table 1 discloses preferred embodiments of the treatment solution according to this invention. For the one skilled in the art of phosphating it is obvious that the preferred compounds employed for the formulation of the treatment solution undergo various chemical reactions and thus shall not be understood as analytically detectable constituents of the treatment solution.

TABLE 1
Compositions of the treatment solution for the preparation of thin
inorganic/organic hybrid coatings on zinciferous substrates

| | | Composition 1 | | Composition 2 | | Composition 3 | |
|---|---|---|---|---|---|---|---|
| | Compound | wt.-% | mM | wt.-% | mM | wt.-% | mM |
| A | H₃PO₄ | 1.65 | 169 | 2.64 | 269 | 2.71 | 276 |
| B1 | H₂TiF₆ | 1.28 | 78 | 1.61 | 98 | 1.65 | 101 |
| B2 | H₂SiF₆ | — | — | 0.07 | 4.7 | 0.07 | 4.7 |
| C1 | ZnO | 0.19 | 23 | 0.36 | 44 | 0.37 | 45 |
| C2 | MnCO₃ | 0.42 | 37 | 0.82 | 71 | 0.84 | 73 |
| D | (NH₄)₆Mo₇O₂₄•4H₂O | 0.09 | 0.73 | 0.18 | 1.46 | 0.18 | 1.46 |
| E | Poly(5-vinyl-2-hydroxy-N- | 0.71 | 0.55 | 2.11 | 1.61 | 1.57 | 1.21 |
| | benzyl-N-glucamine) n = 40 | | | | | | |
| F | PRIMAL ®/water based | 40.0 | n.s. | 35.2 | n.s. | 36.0 | n.s. |
| | acrylic emulsion | (18.4) | | (16.2) | | (16.6) | |
| | (solid content 46%) | | | | | | |
| G | AQUASLIP ®/oxidized | 1.5 | n.s. | 1.5 | n.s. | 1.5 | n.s. |
| | polyethylene wax | (0.57) | | (0.57) | | (0.57) | |
| | (solid content 30%) | | | | | | |

A preferred chelating poly(vinylphenol) compound is Poly(5-vinyl-2-hydroxy-N-benzyl-N-glucamine) which is synthesized via a Mannich type reaction of the components N-methyl-glucamine, formaldehyde and poly(4-vinylphenol) as described in detail in U.S. Pat. No. 5,298,289. The film forming water-dispersable polymer (F) and the wax compound (G) are represented by commercial products PRIMAL® (Rohm and Haas Co.) and AQUASLIP® (Noveon Inc.), respectively.

All compositions (1-3) revealed a sufficient compatibility of the inorganic components with the polymeric resin and proved to be highly stable up to temperatures of 45° C.

The treatment solutions according to Table 1 have been applied to different zinc coated steel metal sheets such as GALVALUME®, GALFAN® and HDG (Table 2) via a roller process and dried thereafter at a certain peak metal temperature (PMT).

TABLE 2
Coating preparation conditions and coating performance for
different substrates and treatment solution compositions

| Compo- | | PMT/ | FW/ | | |
|---|---|---|---|---|---|
| sition | Substrate | ° C. | gm⁻² | NSST | SR/mΩ |
| 1 | GALVALUME ® | 100 | 0.9 | <5%/200 h | n.s. |
| 2 | HDG | 100 | 0.7 | <5%/120 h | 0.5-1 |
| 2 | GALFAN ® | 65 | 0.7 | <5%/72 h | n.s. |
| 3 | HDG | 100 | 0.6 | <5%/72 h | 0.5-1 |
| 3 | GALFAN ® | 65 | 0.8 | <3%/72 h | n.s. |

PMT: Peak Metal Temperature
FW: Film Weight
NSST: Standardized Salt Spray Test (ASTM B117-03)/Performance evaluated by means of white rust coverage
SR: Surface Resistance (Loresta 4-Point Resistance Measurement/IBM SG-PR-000857)
n.s. not specified

For GALFAN® substrates the PMT required to form a homogeneous hybrid coating is at least 65° C., whereas the other zinc coated steel substrates had to be dried at a PMT of 100° C. Depending on the composition and on the wet film thickness of the treatment solution that adheres to the metal sheet directly after the roller application different coatings with a specific film weight (FW) between 0.6 and 0.9 g/m² have been realized.

The zinc coated steel metal sheets treated according to the preferred embodiments of this invention were characterized by means of their anti-corrosion performance using a standardized neutral salt spray test (NSST, ASTM B117-03). All substrates coated with a treatment solution according to this invention revealed excellent corrosion properties with at least less than 5% white rust coverage after 72 h of neutral salt spray test.

At low film weights of about 0.7 g/m² the surface resistance (SR) of the hybrid coating measured with a 4-point probe technology (Loresta-EP, DIA Instruments Co., Ltd.), while the coating is being loaded with a probe weight of 1.2 kg, is less than 1 mω and thus fulfils the IBM standard (IBM SG-PR-000857) required for a material to be used in product enclosures designed for the shielding of electromagnetic fields.

According to these embodiments of the invention the treatment solution when applied to a zinciferous metal substrate yields a thin organic-inorganic hybrid coating that provides a homogeneous coverage of the metal substrate when applied in a dry-in-place process yielding excellent temporary anti-corrosion performance.

Additionally, the metal material being treated according to this invention exhibits a low surface resistance and can be used as a part in electronic housing or white good production to effectively protect the device from electromagnetically induced damages.

The treatment solution itself proves to be highly stable against segregation and/or precipitation, which improves the reliability of the coating process and reduces the costs related to control of solution performance and the number of renewal cycles.

What is claimed is:

1. A treatment solution for the deposition of a thin organic/inorganic hybrid coating on a zinciferous metal surface, comprising water and
(i) a concentration of phosphoric acid (A);
(ii) a concentration of dissolved inorganic components (B) containing at least one complex fluoro metallate anion selected from titanium, zirconium, hafnium and/or silicon;
(iii) a concentration of dissolved inorganic components (C) consisting of bivalent cations of:
zinc (C₁); or
zinc (C₁) and manganese (C₂);
(iv) a concentration of a dissolved inorganic component (D) consisting of oxoanions of molybdenum;
(v) a concentration of a water soluble and/or water dispersable polymeric compound (E), said polymeric compound consisting of a number (n) of monomer units conforming to the general formula
x-(N-R₁-N-R₂-aminomethyl)-4-hydroxy-styrene
where x=2, 3, 5 or 6;
R₁ represents an alkyl group containing from 1 to 4 carbon atoms; and
R₂ represents a chelating moiety substituent group conforming to the general formula
H(CHOH)ₘCH₂—
where m is an integer from 3 to 5, said substituent group being capable of chelating component (B) and/or (C);
(vi) a concentration of a water-soluble and/or water-dispersable polymeric resin (F) being not part of or identical to component (E),
wherein a molar ratio (C₁): (n·E) of the zinc cations (C₁) to the chelating moieties of the polymeric compound (E), with (n·E) being the number (n) of monomer units of the polymeric compound (E), is not more than the stoichiometric ratio, but at least 0.34.

2. The treatment solution according to claim 1 providing stability against segregation of the dissolved, dispersed or both dissolved and dispersed resin (F) up to a temperature of at least 30° C., but not more than 45° C. wherein molar concentration of components (A) to (D) of said treatment solution result in molar ratios such that:
(i) molar ratio (B): (A), calculated as total equivalent hydrogen concentration of the components (B) containing complex fluoro metallate anions and equivalent hydrogen concentration of phosphoric acid (A), is at least 0.1, but not more than 0.6;
(ii) molar ratio (B): (C₁) of the components (B) and (C₁) is at least 2.0, but not more than 3.5 and/or molar ratio (B): (C₂) of the components (B) and (C₂) is at least 1.2, but not more than 2.4;
(iii) molar ratio (D): (C₁) of the components (D) and (C₁) is at least 1:50, but not more than 1:20 or molar ratio (D): (C₂) of the components (D) and (C₂) is at least 1:80, but not more than 1:20.

3. The treatment solution according to claim 1 wherein component (C₁) is present and molar ratio (C₁): (n·E) of the zinc cations (C₁) to the chelating moieties of the polymeric compound (E), with (n·E) being the number (n) of monomer units of the polymeric compound (E), is preferably not more than 0.75, but preferably at least 0.68.

4. The treatment solution according to claim 1 wherein phosphoric acid (A) is present in said solution in an amount of at least 0.5 wt.-%, but not more than 3.0 wt.-%.

5. The treatment solution according to claim 1 wherein bivalent cations supplied by the dissolved inorganic compounds (C) in said solution are present in a total amount that is at least 0.2 wt.-%, but not more than 1.2 wt.-%.

6. The treatment solution according claim 1 wherein mass of the water-soluble and/or water-dispersable polymeric resin (F) in the treatment solution is at least 5 wt.-%, but not more than 50 wt.-%.

7. The treatment solution according to claim 1 wherein the water-soluble and/or water-dispersable polymeric resin (F) has a film formation temperature not higher than 80° C.

8. The treatment solution according to claim 1 wherein said solution additionally contains a stable dispersed solid material (G) that in isolated form has a coefficient of static friction, measured between said solid material and cold rolled steel, that is not greater than 0.35, where a mass ratio of component (G) to component (F) is at least 0.01, but not more than 1.

9. The treatment solution according to claim 8 wherein said solid material is based on oxidized polyethylene wax.

10. The treatment solution according to claim 1 wherein said treatment solution when applied to a zinciferous metal surface forms an organic/inorganic hybrid coating with a film weight of at least 0.4 g/m², but not more than 1.6 g/m².

11. The treatment solution according to claim 1 wherein said treatment solution when applied to zinciferous metal surface forms an organic/inorganic hybrid coating while drying at peak metal temperature of at least 50° C.

12. A process for treating a zinciferous metal surface comprising:
applying a treatment solution according to claim 1 to a zinciferous metal surface;
conversion of the surface; and
evaporation of volatile compounds;
thereby forming a thin organic/inorganic hybrid coating with a film weight of at least 0.4 g/m², but not more than 1.6 g/m².

13. The process according to claim 12 wherein evaporation takes place at a peak metal temperature of not more than 150° C. but at least 65° C.

14. A zinciferous metal substrate having a thin organic/inorganic hybrid coating deposited thereon, said coating having a film weight of at least 0.4 g/m², but not more than 1.6 g/m² obtained by a process according to claim 12.

15. A zinciferous metal substrate according to claim 14, wherein surface resistance of said substrate determined with a 4-point resistance measurement method according to industrial standard IBM SG-PR-000857 is not more than 1.5 mω.
